(19) United States
(12) Patent Application Publication
(10) Pub. No.: US 2026/0235852 A1
(43) Pub. Date: Aug. 13, 2026

(54) OPTICAL SYSTEM AND IMAGE PICKUP APPARATUS

(71) Applicant: CANON KABUSHIKI KAISHA, Tokyo (JP)

(72) Inventor: Tatsuro WATANABE, Tochigi (JP)

(21) Appl. No.: 19/434,445

(22) Filed: Dec. 29, 2025

(30) Foreign Application Priority Data
Feb. 13, 2025 (JP) 2025-021520

(51) Int. Cl. G02B 13/00; H04N 23/55

(52) U.S. Cl. CPC G02B 13/0045; G02B 13/006; H04N 23/55

(57) ABSTRACT

An optical system includes, in order from an object side to an image side, a first lens unit with positive refractive power, a second lens unit with positive refractive power, and a third lens unit. During focusing, each distance between adjacent lens units changes. During focusing, the first and third lens units do not move and the second lens unit moves. The first lens unit includes, in order from the object side to the image side, a first negative lens and a second negative lens.

### BACKGROUND

### Field of the Technology

The aspect of the disclosure relates to one or more embodiments of an optical system and an image pickup apparatus.

### Description of the Related Art

As an optical system for imaging, Japanese Patent Application Laid-Open No. 2023-19073 discloses an optical system that includes, in order from the object side toward the image side, a first lens unit with positive refractive power, a second lens unit with positive refractive power, and a third lens unit with positive refractive power. This optical system is called an inner-focus type optical system that performs focusing by moving the second lens unit.

### SUMMARY

One or more embodiments of an optical system according to one or more aspects of the disclosure may include, in order from an object side to an image side, a first lens unit with positive refractive power, a second lens unit with positive refractive power, and a third lens unit. During focusing, each distance between adjacent lens units changes. During focusing, the first and third lens units do not move and the second lens unit moves. The first lens unit includes, in order from the object side to the image side, a first negative lens and a second negative lens. The following inequalities are satisfied:

$$2.7 \leq f 2 / f \leq 10 \text{.00}$$

$$0.5 \leq f 1 / f 2 \leq 2.80$$

where f2 is a focal length of the second lens unit, f is a focal length of the optical system, and f1 is a focal length of the first lens unit. An image pickup apparatus having the above optical system constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIGS. 2A and 2B are longitudinal aberration diagrams of the optical system according to Example 1 in an in-focus state on an object at infinity and in an in-focus state at a distance where the lateral magnification becomes −0.1, respectively.

FIG. 3 is a sectional view of an optical system according to Example 2.

FIGS. 4A and 4B are longitudinal aberration diagrams of the optical system according to Example 2 in an in-focus state on an object at infinity and in an in-focus state at a distance where the lateral magnification becomes −0.1, respectively.

FIG. 5 is a sectional view of an optical system according to Example 3.

FIGS. 6A and 6B are longitudinal aberration diagrams of the optical system according to Example 3 in an in-focus state on an object at infinity and in an in-focus state at a distance where the lateral magnification becomes −0.1, respectively.

FIG. 7 is a sectional view of an optical system according to Example 4.

FIGS. 8A and 8B are longitudinal aberration diagrams of the optical system according to Example 4 in an in-focus state on an object at infinity and in an in-focus state at a distance where the lateral magnification becomes −0.1, respectively.

FIG. 9 is a sectional view of an optical system according to Example 5.

FIGS. 10A and 10B are longitudinal aberration diagrams of the optical system according to Example 5 in an in-focus state on an object at infinity and in an in-focus state at a distance where the lateral magnification becomes −0.1, respectively.

FIG. 11 illustrates an image pickup apparatus including any one of the optical systems according to Examples 1 to 5.

### DESCRIPTION OF THE EMBODIMENTS

Referring now to the accompanying drawings, a description will be given of examples according to the disclosure.

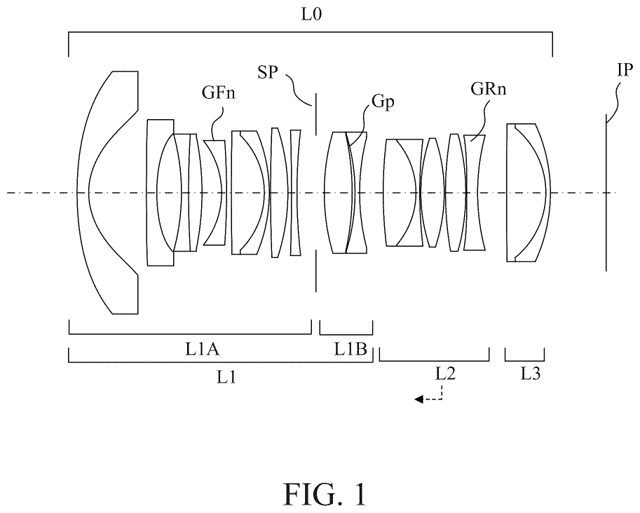

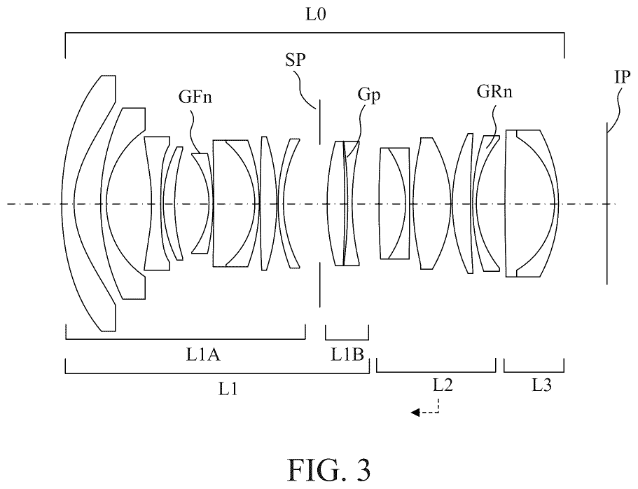

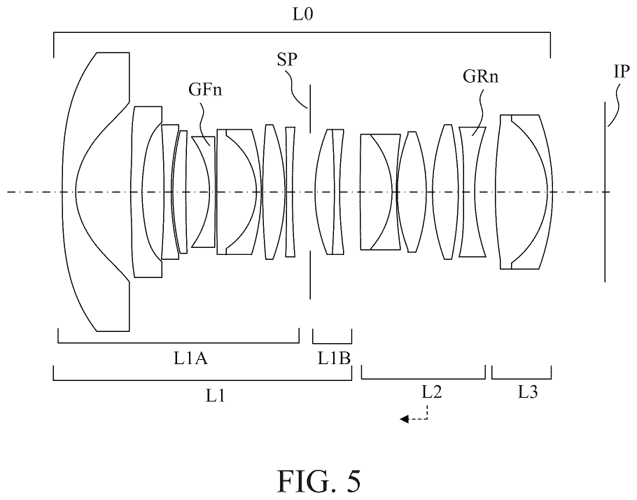

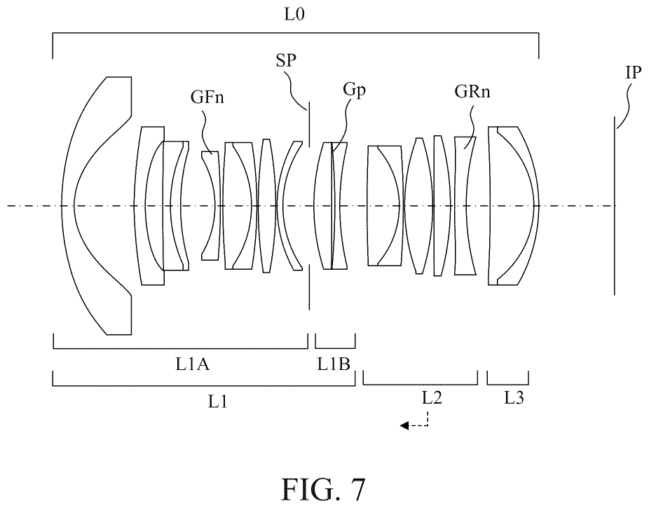

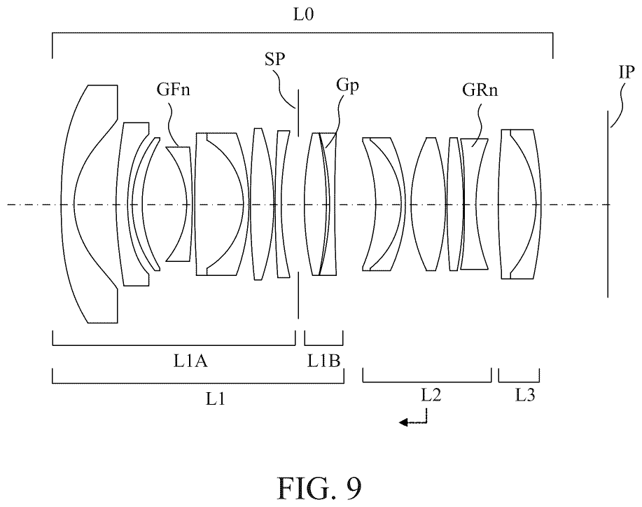

FIGS. 1, 3, 5, 7, and 9 respectively illustrate sectional views of optical systems L0 according to Examples 1 to 5 in an in-focus state on an object at infinity (referred to as “in an in-focus state at infinity” hereinafter).

The optical systems according to the respective examples are used as imaging optical systems in image pickup apparatuses such as video cameras, digital still cameras, film-based cameras, and TV cameras. The optical systems according to the respective examples may also be used as projection optical systems of image projection apparatuses such as projectors.

In each sectional view, the left side is the object side (front side), and the right side is the image side (rear side). In a case where i is the order of the lens unit counted from the object side, Li is the i-th lens unit. A lens unit is a group of one or more lenses that move or do not move integrally relative to the image plane during focusing, and each distance between adjacent lens units changes during focusing. A lens unit may include an aperture stop.

In each sectional view, a broken-line arrow is illustrated below a second lens unit L2, which moves during focusing, indicating a moving direction of the second lens unit L2 during focusing from infinity to a close distance. In each example, only the second lens unit L2 moves toward the object side during focusing from infinity to a close distance.

In each sectional view, SP denotes an aperture stop that determines (limits) a light beam corresponding to the maximum aperture. IP is an image plane. An imaging surface (light receiving surface) of an image sensor, such as a CCD sensor or CMOS sensor, or a film surface (photosensitive surface) of silver film, is disposed on the image plane IP.

The characteristic configuration of the optical system L0 according to each example will be described below.

The optical system L0 according to each example includes, in order from the object side to the image side, a first lens unit L1 with positive refractive power, a second lens unit L2 with positive refractive power, and a third lens unit L3. Only the second lens unit L2 moves during focusing. The first lens unit L1 includes a first negative lens and a second negative lens arranged in this order from the object side.

In the optical system L0 according to each example, a light beam converged by the first lens unit L1 with positive refractive power enters the second lens unit L2 with positive refractive power. This configuration makes it easy to reduce the lens diameter of the second lens unit L2, which moves during focusing, and allows the second lens unit L2 to be made lightweight. As a result, the size and weight of the optical system L0 can be easily reduced.

In a wide-angle optical system, strong negative refractive power is required on the object side of the optical system to secure sufficient back focus. Thus, in the optical systems L0 according to the respective examples, the first lens unit L1 consists of the first negative lens and the second negative lens, and the strong negative refractive power is shared between these two negative lenses. This makes it possible to reduce the refractive power per negative lens, facilitating the correction of barrel distortion and curvature of field.

In the optical systems L0 according to the respective examples, the third lens unit L3 is disposed at a sufficiently separated position, in a direction orthogonal to the optical axis, between the on-axis light beam and the peripheral light beam on the image side of the second lens unit L2, which moves during focusing. This configuration enables correction of astigmatism and distortion while reducing the effect on spherical aberration correction, making it easy to achieve high optical performance across the entire angle of view.

The optical system L0 having the above configuration may satisfy at least one of the following inequalities (1) and (2):

$$2.7 \leq f 2 / f \leq 10 \text{.00} \qquad ( 1 )$$

$$0.5 \leq f 1 / f 2 \leq 2.80 \qquad ( 2 )$$

where f2 is a focal length of the second lens unit L2, f is a focal length of the optical system L0, and f1 is a focal length of the first lens unit L1.

Inequality (1) defines a proper relationship between the focal length of the second lens unit L2 and that of the optical system L0.

In a case where the focal length of the second lens unit L2 increases so that f2/f is higher than the upper limit of inequality (1), a moving amount of the second lens unit L2 during focusing and the overall length of the optical system L0 increase. Thereby, it becomes difficult to reduce the size of the optical system L0. In a case where the focal length of the second lens unit L2 reduces so that f2/f becomes lower than the lower limit of inequality (1), its refractive power becomes excessively strong, and it becomes difficult to suppress spherical aberration, curvature of field, and lateral chromatic aberration during focusing.

The lower limit of inequality (1) may be 2.72, 2.74, 2.76, or 2.77. The upper limit of inequality (1) may be 8.00, 6.00, 5.00, 4.00, or 3.80.

Inequality (2) defines a proper relationship between the focal length of the first lens unit L1 and that of the second lens unit L2.

In a case where the focal length of the first lens unit L1 increases f1/f2 becomes higher than the upper limit of inequality (2), the diameter of the on-axis light beam incident on the second lens unit L2 and the size of the second lens unit L2 increase. As a result, it becomes difficult to reduce the size of the optical system L0. In a case where the focal length of the first lens unit L1 reduces so that f1/f2 becomes lower than the lower limit of inequality (2), a large incident angle for off-axis rays incident on the second lens unit L2 increases, and it becomes difficult to suppress angle-of-view fluctuations during focusing.

The lower limit of inequality (2) may be 0.55, 0.60, 0.65, or 0.68. The upper limit of inequality (2) may be 2.70, 2.65, or 2.60.

Satisfying the above configuration and conditions can achieve an optical system that has a reduced size and weight and high optical performance over the entire angle of view, can perform focusing to a close distance, and exhibits suppressed variation in performance and angle of view during focusing.

The optical system L0 according to each example may satisfy at least one of the following configurations and inequalities (3) to (17).

In the optical system L0 according to each example, the first lens unit L1 may include the aperture stop SP. Thereby, the aperture stop SP may be disposed near the center of the optical system L0, reducing imbalance in lens diameters between the object side and the image side of the optical system L0. As a result, the diameter of the optical system L0 can be easily reduced.

At least one of the lens surfaces on the object side and image side of each of the first negative lens and the second negative lens of the first lens unit L1 may be aspherical. This facilitates the correction of the curvature of field and distortion. Suppressing these aberrations can reduce the number of lenses, and reduce the size and weight of the optical system L0.

In the optical system L0 according to each example, the second lens unit L2 may include at least two positive lenses and at least two negative lenses. This can easily suppress longitudinal and lateral chromatic aberrations, and spherical aberration and curvature of field that occur during focusing.

In the optical system L0 according to each example, let f3 be a focal length of the third lens unit L3, let f1A be a focal length of a subunit disposed closer to the object than the aperture stop SP in the first lens unit L1, and let f1B be a focal length of a subunit disposed closer to the image plane than the aperture stop SP in the first lens unit L1. Let BF be an air-equivalent distance (back focus) on the optical axis from the lens surface closest to the image plane in the optical system L0 to the image plane IP, and let DSI be an on-axis distance from the aperture stop SP to the image plane IP. β2 is a lateral magnification of the second lens unit L2 in the in-focus state at infinity, and β3 is a lateral magnification of the third lens unit L3 in the in-focus state at infinity.

Among the at least one negative lens included in the second lens unit L2, fGRn is a focal length of the negative lens GRn that is closest to the image plane. D23 is an on-axis distance from the lens surface closest to the image plane in the second lens unit L2 to the lens surface closest to the object in the third lens unit L3 in the in-focus state at infinity. Let fG1G2 be a combined focal length of the first negative lens G1 and the second negative lens G2 in the first lens unit L1. Let D2Max be a maximum air gap on the optical axis in the second lens unit L2.

Let rG1R1 be a paraxial radius of curvature of the object-side lens surface of the first negative lens G1, and let rG1R2 be a paraxial radius of curvature of the image-side lens surface of the first negative lens G1. Let rG2R1 be a paraxial radius of curvature of the object-side lens surface of the second negative lens G2, and let rG2R2 be a paraxial radius of curvature of the image-side lens surface of the second negative lens G2. Let νdGFn be an Abbe number based on the d-line of a negative lens GFn that is closest to the object among at least one negative lens having a lens surface convex toward the image side in the first lens unit L1. Let fGFn be a focal length of the negative lens GFn, which is disposed closest to the object in the first lens unit L1 and has a lens surface convex toward the image side.

Let fGp be a focal length of the positive lens Gp included in the first lens unit L1. Let νdp be an Abbe number based on the d-line of the positive lens Gp included in the first lens unit L1, and let ΔθgFp be an anomalous partial dispersion of the positive lens Gp for the g-line and F-line. ΔθgFp is expressed using the Abbe number νdp and the partial dispersion ratio θgFp as follows:

$$Δθ gFp = θ gFp - ( B 3 \times ν {dp}^{3} + B 2 \times ν {dp}^{2} + B 1 \times ν dp + B 0 )$$

$$B 3 = - 7.00 \times 1 {0}^{- 8}$$

$$B 2 = 1.2 \times 1 {0}^{- 4}$$

$$B 1 = - 9.9 \times 1 {0}^{- 3}$$

$$B 0 = 7.50 \times 1 {0}^{- 1}$$

The definitions of the Abbe number νdp and the partial dispersion ratio θgFp will be explained later.

$$1. \leq f 1 B / f 2 \leq 9 \text{.00} \qquad ( 3 )$$

$$- 0.3 \; 0 \leq f / f 1 A \leq 0.30 \qquad ( 4 )$$

$$0.1 \leq BF / DSI \leq 0.35 \qquad ( 5 )$$

$$- 0.3 \; 0 \leq f / f 3 \leq 0.30 \qquad ( 6 )$$

$$0.8 \leq f / BF \leq 1.5 \qquad ( 7 )$$

$$0.5 \leq ( 1 - β22 ) \times β 32 \leq 1.10 \qquad ( 8 )$$

$$- 3. \leq f GRn / f 2 \leq - 0.50 \qquad ( 9 )$$

$$0.01 \leq D 2 Max / D 23 \leq 0.60 \qquad ( 10 )$$

$$- 4. \leq ( rG 1 R 2 + rG 1 R 1 ) / ( rG 1 R 2 - rG 1 R 1 ) \leq - 1. \qquad ( 11 )$$

$$- 4. \leq ( rG 2 R 2 + rG 2 R 1 ) / ( rG 2 R 2 - rG 2 R 1 ) \leq - 1. \qquad ( 12 )$$

$$- 3. \leq fG 1 G 2 / f \leq - 0 \text{.80} \qquad ( 13 )$$

$$81. \leq ν dGFn \leq 100. \qquad ( 14 )$$

$$- 6.5 \leq f GFn / f \leq - 2 \text{.00} \qquad ( 15 )$$

$$0.05 \leq Δ θ gFp \leq 0.25 \qquad ( 16 )$$

$$0.02 \leq f / fGp \leq 0.090 \qquad ( 17 )$$

Inequality (3) defines a proper relationship between the focal length of the subunit in the first lens unit L1 disposed closer to the image plane than the aperture stop SP and the focal length f2 of the second lens unit L2. In a case where f1B increases so that f1B/f2 becomes higher than the upper limit of inequality (3), the on-axis light beam diameter incident on the second lens unit L2 increases, and it becomes difficult to reduce the size of the second lens unit L2. Moreover, the angle from the optical axis of the off-axis rays incident on the second lens unit L2 increases, and it becomes difficult to suppress fluctuations in angle of view during focusing. In a case where f1B is reduced so that f1B/f2 becomes lower than the lower limit, it becomes difficult to suppress longitudinal chromatic aberration, spherical aberration, and coma.

The lower limit of inequality (3) may be set to 1.20, 1.50, 1.60, or 1.70. The upper limit of inequality (3) may be set to 8.00, 7.50, 7.00, or 6.60.

Inequality (4) defines a proper relationship between the focal length of the optical system L0 and the focal length of a subunit closest to the object than the aperture stop SP in the first lens unit L1. In a case where the positive refractive power of the subunit on the object side increases so that f/f1A becomes higher than the upper limit of inequality (4), the lens diameter on the image side of the optical system L0 increases and it becomes difficult to reduce the size of the optical system L0. In a case where the negative refractive power of the subunit on the object side increases so that f/f1A becomes lower than the lower limit of inequality (4), the lens diameters before and after the aperture stop SP increase, and it becomes difficult to reduce the size of the optical system L0. On the image side of the aperture stop SP, separation between on-axis and off-axis light beams becomes difficult, and it becomes difficult to correct astigmatism.

The lower limit of inequality (4) may be set to −0.20, −0.15, −0.10, or −0.08. The upper limit of inequality (4) may be set to 0.25, 0.20, or 0.17.

Inequality (5) defines a proper relationship between the back focus of the optical system L0 and the distance from the aperture stop SP to the image plane IP. In a case where BF increases so that BF/DSI becomes higher than the upper limit of inequality (5), the height from the optical axis of off-axis light beams incident on the optical system L0 increases, and it becomes difficult to reduce the lens diameter on the object side of the optical system L0. In a case where BF decreases so that BF/DSI becomes lower than the lower limit of inequality (5), separation between axial and off-axial light beams becomes insufficient even near the image plane IP, and it becomes difficult to suppress sagittal coma flare and astigmatism.

The lower limit of inequality (5) may be set to 0.12, 0.14, or 0.15. The upper limit of inequality (5) may be set to 0.30, 0.28, or 0.26.

Inequality (6) defines a proper relationship between the focal length of the optical system L0 and the focal length of the third lens unit L3. In a case where the positive refractive power of the third lens unit L3 increases so that f/f3 becomes higher than the upper limit of inequality (6), it becomes difficult to suppress barrel-type distortion. In a case where the negative refractive power of the third lens unit L3 increases so that f/f3 becomes lower than the lower limit of inequality (6), it becomes difficult to suppress fluctuations in the angle of view during focusing.

The lower limit of inequality (6) may be set to −0.20, −0.15, −0.10, or −0.04. The upper limit of inequality (6) may be set to 0.25, 0.20, 0.15, or 0.13.

Inequality (7) defines a proper relationship between the focal length of the optical system L0 and the back focus. In a case where f/BF becomes higher than the upper limit of inequality (7), it becomes difficult to suppress curvature of field and distortion and secure sufficient back focus. In a case where f/BF becomes lower than the lower limit of inequality (7), it becomes difficult to reduce the lens diameter on the object side of a wide-angle optical system.

The lower limit of inequality (7) may be set to 0.82, 0.85, 0.88, or 0.90. The upper limit of inequality (7) may be set to 1.45, 1.40, or 1.35.

Inequality (8) defines a proper range of focus sensitivity of the second lens unit L2 (the ratio of the moving amount of the image plane IP to the moving amount of the second lens unit L2). In a case where the focus sensitivity becomes higher than the upper limit of inequality (8), the positive refractive power of the second lens unit L2 becomes excessively strong, and it becomes difficult to reduce the fluctuations in the angle of view during focusing. In a case where the focus sensitivity becomes lower than the lower limit of inequality (8), the moving amount of the second lens unit L2 becomes excessively large during focusing on a close object, and it becomes difficult to reduce the overall length of the optical system L0.

The lower limit of inequality (8) may be set to 0.55, 0.60, 0.65, or 0.70. The upper limit of inequality (8) may be set to 1.00, 0.95, 0.90, or 0.85.

Inequality (9) defines a proper relationship between the focal length of the negative lens GRn closest to the image plane in the second lens unit L2 and the focal length of the second lens unit L2. In a case where the negative refractive power of the negative lens GRn becomes excessively strong so that fGRn/f2 becomes higher than the upper limit of inequality (9), the Petzval sum of the optical system L0 becomes excessively small, and it becomes difficult to correct curvature of field. In a case where the negative refractive power of the negative lens GRn becomes excessively weak so that fGRn/f2 becomes lower than the lower limit of inequality (9), it becomes difficult to suppress sagittal coma flare.

The lower limit of inequality (9) may be set to −2.70, −2.60, −2.55, or −2.50. The upper limit of inequality (9) may be set to −0.60, −0.65, or −0.70.

Inequality (10) defines a proper relationship between the maximum air gap (distance) in the second lens unit L2 and the distance from the lens surface closest to the image plane in the second lens unit L2 to the lens surface closest to the object in the third lens unit L3 in the in-focus state at infinity. In a case where the thickness on the optical axis of the second lens unit L2 becomes excessively large so that D2Max/D23 becomes higher than the upper limit of inequality (10), the size of the mechanism for driving the second lens unit L2 increases, and it becomes difficult to reduce the size and weight of the optical system L0. In a case where D2Max/D23 becomes lower than the lower limit of inequality (10), it becomes difficult to suppress the generation of spherical aberration during focusing.

The lower limit of inequality (10) may be set to 0.02, 0.03, or 0.04. The upper limit of inequality (10) may be set to 0.50, 0.45, 0.40, or 0.35.

Inequality (11) defines a proper range of the shape factor representing the shape of the first negative lens in the first lens unit L1. In a case where the shape factor becomes higher than the upper limit of inequality (11), it becomes difficult to suppress astigmatism while the diameter of the first negative lens is reduced. In a case where the shape factor becomes lower than the lower limit of inequality (11), it becomes difficult to suppress barrel-type distortion.

The lower limit of inequality (11) may be set to −3.50, −3.00, −2.50, or −2.20. The upper limit of inequality (11) may be set to −1.04, −1.06, −1.08, or −1.00.

Inequality (12) defines a proper range of the shape factor representing the shape of the second negative lens in the first lens unit L1. In a case where the shape factor becomes higher than the upper limit of inequality (12), it becomes difficult to correct curvature of field. In a case where the shape factor becomes lower than the lower limit of inequality (12), it becomes difficult to suppress distortion and astigmatism.

The lower limit of inequality (12) may be set to −3.90, −3.80, or −3.70. The upper limit of inequality (12) may be set to −1.10, −1.20, or −1.30.

Inequality (13) defines a proper relationship between the combined focal length of the first negative lens and the second negative lens in the first lens unit L1 and the focal length of the optical system L0. In a case where combined negative refractive power of the first and second negative lenses becomes stronger so that fG1G2/f becomes higher than the upper limit of inequality (13), it becomes difficult to suppress barrel-type distortion and lateral chromatic aberration. In a case where combined negative refractive power of the first and second negative lenses becomes weaker so that fG1G2/f becomes lower than the lower limit of inequality (13), the Petzval sum of the optical system L0 becomes excessively large, and it becomes difficult to correct curvature of field. Further, it becomes difficult to reduce the lens diameter on the object side of the optical system L0.

The lower limit of inequality (13) may be set to −2.80, −2.50, −2.20, or −2.10. The upper limit of inequality (13) may be set to −1.00, −1.10, or −1.20. Inequality (14) defines a proper range for the Abbe number of the negative lens GFn in the first lens unit L1. Since the first lens unit L1 includes a negative lens whose convex surface faces the image side, it becomes easier to correct the higher-order curvature of field. In a case where νdGFn becomes higher than the upper limit of inequality (14), the primary achromatism in the lateral chromatic aberration becomes over-corrected. In a case where νdGFn becomes lower than the lower limit of inequality (14), it becomes difficult to suppress the occurrence of lateral chromatic aberration.

The lower limit of inequality (14) may be set to 85.0, 88, 90.0, or 93.0. The upper limit of inequality (14) may be set to 99.0, 98.0, 97.0, or 96.0.

Inequality (15) defines a proper relationship between the focal length of the negative lens GFn and the focal length of the optical system L0. In a case where the negative refractive power of the negative lens GFn becomes stronger such that fGFn/f becomes higher than the upper limit of inequality (15), it becomes difficult to correct higher-order curvature of field. Additionally, the wavelength dependence of curvature of field increases, and it becomes difficult to correct curvature of field over a wide wavelength range. In a case where the negative refractive power of the negative lens GFn becomes weaker such that fGFn/f becomes lower than the lower limit of inequality (15), the effect of correcting lateral chromatic aberration becomes small.

The lower limit of inequality (15) may be set to −6.00, −5.50, −4.50, or −4.30. The upper limit of inequality (15) may be set to −2.20, −2.40, −2.50, or −2.60.

Inequality (16) defines a proper range for the anomalous partial dispersion of the positive lens Gp in the first lens unit L1. In a case where ΔθgFp becomes higher than the upper limit of inequality (16), the secondary achromatism of longitudinal chromatic aberration becomes over-corrected. In a case where ΔθgFp becomes lower than the lower limit of inequality (16), the secondary achromatism of longitudinal and lateral chromatic aberrations becomes insufficient.

The lower limit of inequality (16) may be set to 0.080, 0.100, 0.140, or 0.170. The upper limit of inequality (16) may be set to 0.240, 0.220, 0.200, or 0.185.

Inequality (17) defines a proper range for the relationship between the focal length of the positive lens Gp and the focal length of the optical system L0. In a case where the positive refractive power of the positive lens Gp becomes weaker such that f/fGp becomes higher than the upper limit of inequality (17), it becomes difficult to suppress longitudinal chromatic aberration. In a case where the positive refractive power of the positive lens Gp becomes stronger such that f/fGp becomes lower than the lower limit of inequality (17), the wavelength dependence of curvature of field increases, and it becomes difficult to correct curvature of field over a wide wavelength range.

The lower limit of inequality (17) may be set to 0.025, 0.030, 0.035, or 0.040. The upper limit of inequality (17) may be set to 0.080, 0.075, 0.070, 0.065, or 0.060.

The optical systems L0 according to the respective examples will now be described in detail.

The optical systems L0 according to Examples 1, 2, 3, and 4 include a first lens unit L1 with positive refractive power, a second lens unit L2 with positive refractive power, and a third lens unit L3 with positive refractive power. Providing the third lens unit L3 with positive refractive power can reduce the incident angle of off-axis light beams entering the image plane IP, and make it easier to suppress color unevenness when an object is captured by an image sensor such as a CMOS sensor through the optical system L0.

The optical system L0 according to Example 5 includes a first lens unit L1 with positive refractive power, a second lens unit L2 with positive refractive power, and a third lens unit L3 with negative refractive power. Providing the third lens unit L3 with negative refractive power can reduce the Petzval sum, and make it easier to correct curvature of field.

In addition, the incident angle of off-axis rays onto the image plane IP can be increased, and the lens diameter of the third lens unit L3 can be reduced. Furthermore, since the exit pupil position becomes closer to the image plane IP, it becomes easier to shorten the overall lens length.

In the optical systems L0 according to Examples 1, 3, 4, and 5, the first negative lens and the second negative lens of the first lens unit L1 are both aspherical lenses on both surfaces. In the optical system L0 according to Example 2, the first negative lens and the third lens from the object side are aspherical on both surfaces. This allows the correcting effects of distortion and astigmatism to be enhanced. When the aspherical lens on the object side among these two aspherical lenses is shaped such that the absolute value of curvature at the periphery is smaller than the absolute value of curvature on the optical axis, the correction effect of distortion aberration may be further enhanced. When the aspherical lens on the image side among these two aspherical lenses is shaped such that the absolute value of curvature at the periphery is larger than the absolute value of curvature on the optical axis, the correction effect of curvature of field may be further enhanced.

In the optical systems L0 according to Examples 1, 2, and 3, the lens surface on the object side of the third lens counted from the object side is concave. Thereby, the refractive power of the negative air lens formed between the image-side lens surface of the second negative lens and the object-side lens surface of the third lens from the object side becomes stronger. Consequently, the Petzval sum can be reduced, and it becomes easier to correct curvature of field.

In the optical systems L0 according to Examples 1, 2, 4, and 5, the positive lens Gp of the first lens unit L1 is a positive meniscus lens disposed on the image side of the aperture stop SP and with its convex surface facing the image side. Thereby, the positive lens Gp becomes almost concentric relative to the off-axis light beams entering it, and it becomes easier to correct both longitudinal and lateral chromatic aberrations. The positive lens Gp is a resin lens and is cemented between a biconvex lens on the object side and a biconcave lens on the image side. Thereby, environmental durability can be improved.

In the optical systems L0 according to the respective examples, the second lens unit L2 includes three positive lenses and two negative lenses. Thereby, the refractive power of each lens can be weakened, and it becomes easier to correct longitudinal and lateral chromatic aberrations while spherical aberration and curvature of field generated during focusing can be corrected.

In the optical systems L0 according to the respective examples, the second lens unit L2 includes an aspheric lens that has at least one aspherical surface. Thereby, it becomes easier to correct spherical aberration, astigmatism, and coma. Placing the aspheric lens closer to the image plane within the second lens unit L2 can easily correct astigmatism generated during focusing.

In the optical systems L0 according to the respective examples, the negative lens GRn closest to the image plane in the second lens unit L2 has a concave lens surface on the image side as a lens surface on the image side. This allows a strong negative refractive power to be generated on the image side, making it easier to correct sagittal coma flare.

In the optical systems L0 according to the respective examples, the third lens unit L3 includes a cemented lens consisting of a positive lens and a negative lens. This makes it easier to correct lateral chromatic aberration and astigmatism.

Numerical examples 1 to 5 corresponding to Examples 1 to 5 will now be illustrated. In surface data of each numerical example, a surface number m represents the order of the optical surface counted from the object side. r (mm) represents a radius of curvature of an m-th surface, and d (mm) represents a distance along the optical axis between m-th and (m+1)-th surfaces. The refractive index nd represents a refractive index of each optical material for the d-line between m-th and (m+1)-th surfaces. νd and θgF represent, respectively, the Abbe number based on the d-line and the partial dispersion ratio for the g-line and F-line of the optical material. The Abbe number νd based on the d-line and the partial dispersion ratio θgF for the g-line and F-line are expressed as follows:

$$ν d = ( nd - 1 ) / ( n F - nC )$$

$$θ gF = ( n g - n F ) / ( n F - n C )$$

where nd, nF, nC, and ng are refractive indices of the d-line (587.6 nm), F-line (486.1 nm), C-line (656.3 nm), and g-line (435.8 nm) in the Fraunhofer lines.

In each numerical example, the values of d, focal length (mm), F-number, and half angle of field (°) may be given for the optical system in the in-focus state at infinity. The back focus (BF) is, as described above, an air-equivalent distance from the lens surface closest to the image plane (the last surface) in the above optical system to the image plane. The overall lens length is a distance along the optical axis from the lens surface closest to the object (the first surface) in the optical system to the last lens surface, plus the back focus.

An asterisk “*” attached to the surface number means that the surface has an aspherical shape. The aspherical shape is expressed as follows:

$$X = ( {h}^{2} / R ) / [ 1 + {\{ 1 - ( 1 + K ) {( h / R )}^{2} \}}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14}$$

where X is a displacement amount along the optical axis from a surface vertex, h is a height from the optical axis in the direction orthogonal to the optical axis, a light traveling direction is positive, R is a paraxial radius of curvature, K is a conic constant, and A4, A6, A8, A10, A12, and A14 are the aspherical coefficients of respective orders.

In the conic constant and aspherical coefficients, “e±XX” means “×10^{±XX}.”

### Numerical Example 1

### Unit: mm

SURFACE DATA

| Surface No. | r | d | nd | νd | θgF |
|---|---|---|---|---|---|
| 1* | 72.028 | 2.80 | 1.58313 | 59.4 | |
| 2* | 16.266 | 13.91 | | | |
| 3* | 230.372 | 2.50 | 1.85400 | 40.4 | |
| 4* | 36.824 | 5.96 | | | |
| 5 | −52.544 | 1.70 | 1.49700 | 81.7 | |
| 6 | 227.055 | 3.25 | 2.00100 | 29.1 | |
| 7 | −66.875 | 4.72 | | | |
| 8 | −19.936 | 1.20 | 1.43387 | 95.1 | |
| 9 | −174.771 | 1.15 | | | |
| 10 | 666.926 | 7.95 | 1.75500 | 52.3 | |
| 11 | −19.196 | 1.20 | 1.90366 | 31.3 | |
| 12 | −37.194 | 0.30 | | | |
| 13 | 366.220 | 4.19 | 2.00100 | 29.1 | |
| 14 | −49.913 | 0.88 | | | |
| 15 | −452.541 | 1.30 | 1.85478 | 24.8 | |
| 16 | 126.230 | 4.59 | | | |
| 17 (SP) | ∞ | 1.99 | | | |
| 18 | 51.465 | 6.73 | 1.74320 | 49.3 | |
| 19 | −64.595 | 0.70 | 1.57060 | 20.1 | 0.7782 |
| 20 | −47.173 | 1.10 | 1.66565 | 35.6 | |
| 21 | 52.870 | (Variable) | | | |
| 22 | 102.903 | 7.91 | 1.59282 | 68.6 | |
| 23 | −18.997 | 0.90 | 1.85478 | 24.8 | |
| 24 | 104.859 | 0.26 | | | |
| 25 | 40.761 | 5.64 | 1.53775 | 74.7 | |
| 26 | −40.761 | 0.30 | | | |
| 27 | 80.536 | 4.90 | 1.92286 | 20.9 | |
| 28 | −52.817 | 0.24 | | | |
| 29* | −451.581 | 2.60 | 1.85400 | 40.4 | |
| 30 | 52.550 | (Variable) | | | |
| 31 | 1258.224 | 9.47 | 1.59282 | 68.6 | |
| 32 | −19.963 | 1.10 | 2.00100 | 29.1 | |
| 33 | −38.825 | 13.43 | | | |
| Image Plane | ∞ | | | | |

### Aspheric Data

### 1st Surface

K=0.00000e+00 A 4=2.85263e−06 A 6=−1.06525e−09 A 8=6.56552e−12 A10=−1.19824e−14 A12=1.27858e−17 A14=−5.74533e−21

### 2nd Surface

K=−7.63673e−01 A 4=3.24368e−07 A 6=1.38290e−08 A 8=−2.16651e−10 A10=1.03526e−12 A12=−2.85465e−15 A14=2.51224e−18

### 3rd Surface

K=0.00000e+00 A 4=−1.93330e−05 A 6=5.99502e−08 A 8=2.63193e−11 A10=−1.91446e−13

### 4th Surface

K=0.00000e+00 A 4=−1.26314e−06 A 6=8.53091e−08 A 8=3.29375e−10 A10=−1.43389e−12 A12=6.79219e−15

### 29th Surface

K=0.00000e+00 A 4=−1.36198e−05 A 6=−5.53900e−09 A 8=2.76263e−11 A10=−2.94829e−13 A12=7.25340e−16

VARIOUS DATA

| | |
|---|---|
| Focal Length | 14.42 |
| Fno | 1.45 |
| Half Angle of View (°) | 52.40 |
| Image Height | 18.73 |
| Overall Lens Length | 127.50 |
| BF | 13.43 |

| | | In-focus State at |
|---|---|---|
| | | Object Distance |
| | In-focus State | Where Lateral |
| | at Infinity | Magnification is −0.1× |
| From Object Plane | Infinity | 254.067 |
| To Image Plane | | |
| d21 | 5.67 | 3.89 |
| d30 | 6.98 | 8.76 |

LENS UNIT DATA

| Lens Unit | Starting Surface | Focal Length |
|---|---|---|
| 1 | 1 | 60.70 |
| 2 | 22 | 45.36 |
| 3 | 31 | 164.62 |

SINGLE LENS DATA

| Lens | Starting Surface | Focal Length |
|---|---|---|
| 1 | 1 | −36.71 |
| 2 | 3 | −51.63 |
| 3 | 5 | −85.68 |
| 4 | 6 | 51.89 |
| 5 | 8 | −51.99 |
| 6 | 10 | 24.84 |
| 7 | 11 | −45.33 |
| 8 | 13 | 44.10 |
| 9 | 15 | −115.35 |
| 10 | 18 | 39.52 |
| 11 | 19 | 302.13 |
| 12 | 20 | −37.29 |
| 13 | 22 | 27.72 |
| 14 | 23 | −18.75 |
| 15 | 25 | 38.84 |
| 16 | 27 | 35.18 |
| 17 | 29 | −54.99 |
| 18 | 31 | 33.24 |
| 19 | 32 | −42.29 |

### Numerical Example 2

### UNIT: mm

SURFACE DATA

| Surface No. | r | d | nd | νd | θgF |
|---|---|---|---|---|---|
| 1* | 68.228 | 2.80 | 1.58313 | 59.4 | |
| 2* | 22.023 | 6.02 | | | |
| 3 | 48.678 | 1.30 | 1.49700 | 81.7 | |
| 4 | 19.877 | 10.23 | | | |
| 5* | −65.000 | 2.10 | 1.85400 | 40.4 | |
| 6* | 98.359 | 0.58 | | | |
| 7 | 27.484 | 2.58 | 1.77047 | 29.7 | |
| 8 | 41.872 | 7.80 | | | |
| 9 | −17.377 | 0.90 | 1.43875 | 94.7 | |
| 10 | −50.987 | 0.15 | | | |
| 11 | −661.523 | 9.33 | 1.72916 | 54.7 | |
| 12 | −17.758 | 1.00 | 1.84666 | 23.8 | |
| 13 | −39.714 | 0.20 | | | |
| 14 | 317.043 | 3.77 | 2.00100 | 29.1 | |
| 15 | −49.175 | 0.30 | | | |
| 16 | 40.000 | 1.20 | 1.54814 | 45.8 | |
| 17 | 29.455 | 8.25 | | | |
| 18 (SP) | ∞ | 1.66 | | | |
| 19 | 52.664 | 3.98 | 1.91082 | 35.2 | |
| 20 | −300.000 | 0.70 | 1.57060 | 20.1 | 0.7782 |
| 21 | −107.199 | 1.00 | 1.54072 | 47.2 | |
| 22 | 57.316 | (Variable) | | | |
| 23 | 210.839 | 6.03 | 1.43875 | 94.7 | |
| 24 | −21.633 | 0.90 | 1.85478 | 24.8 | |
| 25 | −757.038 | 0.80 | | | |
| 26* | 49.445 | 8.55 | 1.49700 | 81.7 | |
| 27* | −25.759 | 0.35 | | | |
| 28 | 36.498 | 4.10 | 1.92286 | 20.9 | |
| 29 | 213.891 | 0.50 | | | |
| 30 | 47.520 | 0.85 | 1.85478 | 24.8 | |
| 31 | 22.781 | (Variable) | | | |
| 32 | 437.990 | 11.25 | 1.53775 | 74.7 | |
| 33 | −17.377 | 0.90 | 2.00069 | 25.5 | |
| 34 | −34.119 | 11.00 | | | |
| Image Plane | ∞ | | | | |

### Aspheric Data

### 1st Surface

K=0.00000e+00 A 4=8.40179e−06 A 6=−2.16752e−08 A 8=3.89602e−11 A10=−3.74428e−14 A12=2.56441e−17 A14=−1.04282e−20

### 2nd Surface

K=−1.18258e+00 A 4=2.25254e−06 A 6=1.42326e−10 A 8=−2.60579e−10 A10−9.49508e−13 A12=−1.35856e−15 A14=7.06455e−19

### 5th Surface

K=0.00000e+00 A 4=−5.00917e−05 A 6=4.73233e−07 A 8=−1.46028e−09 A10=1.74157e−12

### 6th Surface

K=0.00000e+00 A 4=−2.12787e−05 A 6=4.86543e−07 A 8=−1.14039e−09 A10=9.67632e−13 A12=2.88212e−15

### 26th Surface

K=0.00000e+00 A 4=−8.60844e−06 A 6=6.93515e−09 A 8=8.60818e−11 A10=−4.00880e−13 A12=9.42337e−18

### 27th Surface

K=0.00000e+00 A 4=1.07871e−05 A 6=1.27312e−08 A 8=−2.42671e−10 A10=1.62259e−12 A12=−3.95572e−15

VARIOUS DATA

| | |
|---|---|
| Focal Length | 14.42 |
| Fno | 1.46 |
| Half Angle of View (°) | 51.59 |
| Image Height | 18.18 |
| Overall Lens Length | 123.63 |
| BF | 11.00 |

| | | In-focus State at |
|---|---|---|
| | | Object Distance |
| | In-focus State | Where Lateral |
| | at Infinity | Magnification is −0.1× |
| From Object Plane | Infinity | 247.931 |
| To Image Plane | | |
| d22 | 6.08 | 4.21 |
| d31 | 6.47 | 8.34 |

LENS UNIT DATA

| Lens Unit | Starting Surface | Focal Length |
|---|---|---|
| 1 | 1 | 36.62 |
| 2 | 23 | 51.76 |
| 3 | 32 | 236.68 |

SINGLE LENS DATA

| Lens | Starting Surface | Focal Length |
|---|---|---|
| 1 | 1 | −57.04 |
| 2 | 3 | −68.62 |
| 3 | 5 | −45.56 |
| 4 | 7 | 96.30 |
| 5 | 9 | −60.58 |
| 6 | 11 | 24.87 |
| 7 | 12 | −38.75 |
| 8 | 14 | 42.75 |
| 9 | 16 | −212.39 |
| 10 | 19 | 49.45 |
| 11 | 20 | 291.94 |
| 12 | 21 | −68.92 |
| 13 | 23 | 45.07 |
| 14 | 24 | −26.07 |
| 15 | 26 | 35.41 |
| 16 | 28 | 47.16 |
| 17 | 30 | −52.02 |
| 18 | 32 | 31.35 |
| 19 | 33 | −36.37 |

### Numerical Example 3

### UNIT: mm

SURFACE DATA

| Surface No. | r | d | nd | νd | θgF |
|---|---|---|---|---|---|
| 1* | 267.177 | 2.80 | 1.58313 | 59.4 | |
| 2* | 14.498 | 11.53 | | | |
| 3* | 67.327 | 2.40 | 1.80400 | 46.5 | |
| 4* | 34.774 | 4.61 | | | |
| 5 | −183.000 | 1.50 | 1.43875 | 94.7 | |
| 6 | 54.102 | 0.35 | | | |
| 7 | 53.453 | 2.72 | 1.85478 | 24.8 | |
| 8 | 309.000 | 4.98 | | | |
| 9 | −19.293 | 1.20 | 1.43387 | 95.1 | |
| 10 | −408.469 | 0.29 | | | |
| 11 | 666.691 | 8.34 | 1.83400 | 37.2 | |
| 12 | −14.076 | 1.00 | 2.00100 | 29.1 | |
| 13 | −42.469 | 0.30 | | | |
| 14 | 147.148 | 4.68 | 2.00100 | 29.1 | |
| 15 | −39.771 | 0.35 | | | |
| 16 | −499.877 | 1.20 | 1.80518 | 25.4 | |
| 17 | 177.463 | 3.75 | | | |
| 18 (SP) | ∞ | 1.00 | | | |
| 19 | 34.242 | 4.06 | 1.48749 | 70.2 | |
| 20 | −196.366 | 1.10 | 1.85478 | 24.8 | |
| 21 | 92.200 | (Variable) | | | |
| 22 | 526.322 | 6.70 | 1.59282 | 68.6 | |
| 23 | −17.821 | 0.90 | 1.85478 | 24.8 | |
| 24 | 81.915 | 0.20 | | | |
| 25 | 33.276 | 6.09 | 1.49700 | 81.5 | |
| 26 | −36.575 | 1.28 | | | |
| 27 | 40.274 | 5.42 | 1.92286 | 20.9 | |
| 28 | −70.437 | 1.13 | | | |
| 29* | −719.648 | 2.30 | 1.85400 | 40.4 | |
| 30* | 39.887 | (Variable) | | | |
| 31 | 96.515 | 10.92 | 1.59282 | 68.6 | |
| 32 | −18.249 | 1.10 | 2.00069 | 25.5 | |
| 33 | −45.803 | 10.97 | | | |
| Image Plane | ∞ | | | | |

### Aspheric Data

### 1st Surface

K=0.00000e+00 A 4=1.69844e−05 A 6=−3.17085e−08 A 8=5.48951e−11 A10=−5.97168e−14 A12=3.72776e−17 A14=−1.00928e−20

### 2nd Surface

K=−7.19651e−01 A 4=−1.30351e−05 A 6=1.09004e−07 A 8=−8.61665e−10 A10=3.58174e−12 A12=−1.00862e−14 A14=1.07411e−17

### 3rd Surface

K=0.00000e+00 A 4=−9.08937e−05 A 6=5.19871e−07 A 8=−1.25801e−09 A10=1.16180e−12

### 4th Surface

K=0.00000e+00 A 4=−6.59571e−05 A 6=6.18490e−07 A 8=−1.77781e−09 A10=5.74121e−12 A12=−8.19795e−15

### 29th Surface

K=0.00000e+00 A 4=−2.36034e−05 A 6=−3.46142e−09 A 8=−2.04769e−11 A10=6.75972e−14 A12−−2.13753e−16

### 30th Surface

K=0.00000e+00 A 4=7.67496e−09 A 6=−1.56427e−10 A 8=1.21761e−12 A10=−3.19667e−15

VARIOUS DATA

| | |
|---|---|
| Focal Length | 12.37 |
| Fno | 1.45 |
| Half Angle of View (°) | 56.52 |
| Image Height | 18.70 |
| Overall Lens Length | 113.78 |
| BF | 10.97 |

| | | In-focus State at |
|---|---|---|
| | | Object Distance |
| | In-focus State | Where Lateral |
| | at Infinity | Magnification is −0.1× |
| From Object Plane | Infinity | 222.953 |
| To Image Plane | | |
| d21 | 4.31 | 2.64 |
| d30 | 4.33 | 6.00 |

LENS UNIT DATA

| Lens Unit | Starting Surface | Focal Length |
|---|---|---|
| 1 | 1 | 43.78 |
| 2 | 22 | 45.33 |
| 3 | 31 | 171.13 |

SINGLE LENS DATA

| Lens | Starting Surface | Focal Length |
|---|---|---|
| 1 | 1 | −26.40 |
| 2 | 3 | −92.49 |
| 3 | 5 | −94.99 |
| 4 | 7 | 75.24 |
| 5 | 9 | −46.71 |
| 6 | 11 | 16.62 |
| 7 | 12 | −21.41 |
| 8 | 14 | 31.67 |
| 9 | 16 | −162.53 |
| 10 | 19 | 60.16 |
| 11 | 20 | −73.27 |
| 12 | 22 | 29.21 |
| 13 | 23 | −17.05 |
| 14 | 25 | 36.10 |
| 15 | 27 | 28.43 |
| 16 | 29 | −44.19 |
| 17 | 31 | 26.84 |
| 18 | 32 | −30.93 |

### Numerical Example 4

### UNIT: mm

SURFACE DATA

| Surface No. | r | d | nd | νd | θgF |
|---|---|---|---|---|---|
| 1* | 51.539 | 2.80 | 1.58313 | 59.4 | |
| 2* | 15.371 | 13.33 | | | |
| 3* | 61.291 | 2.50 | 1.85400 | 40.4 | |
| 4* | 35.039 | 3.91 | | | |
| 5 | 649.855 | 1.70 | 1.49700 | 81.7 | |
| 6 | 31.302 | 2.27 | 2.00069 | 25.5 | |
| 7 | 44.812 | 7.68 | | | |
| 8 | −20.849 | 1.20 | 1.43387 | 95.1 | |
| 9 | −141.674 | 0.55 | | | |
| 10 | 150.414 | 6.39 | 1.87070 | 40.7 | |
| 11 | −23.249 | 1.20 | 1.84666 | 23.8 | |
| 12 | −86.168 | 0.30 | | | |
| 13 | 96.682 | 3.91 | 2.00100 | 29.1 | |
| 14 | −79.582 | 0.29 | | | |
| 15 | 29.031 | 1.30 | 1.85478 | 24.8 | |
| 16 | 23.995 | 5.91 | | | |
| 17 (SP) | ∞ | 1.00 | | | |
| 18 | 45.666 | 3.98 | 1.74320 | 49.3 | |
| 19 | −1500.170 | 0.70 | 1.57060 | 20.1 | 0.7782 |
| 20 | −146.486 | 1.10 | 1.62205 | 41.1 | |
| 21 | 56.157 | (Variable) | | | |
| 22 | 326.489 | 7.19 | 1.59282 | 68.6 | |
| 23 | −19.321 | 0.90 | 1.85478 | 24.8 | |
| 24 | −164.893 | 0.29 | | | |
| 25 | 43.177 | 6.25 | 1.53775 | 74.7 | |
| 26 | −49.914 | 0.30 | | | |
| 27 | 4710.975 | 3.65 | 1.92286 | 20.9 | |
| 28 | −58.311 | 0.92 | | | |
| 29* | 151.547 | 2.60 | 1.85400 | 40.4 | |
| 30 | 54.632 | (Variable) | | | |
| 31 | −317.076 | 9.73 | 1.59282 | 68.6 | |
| 32 | −20.352 | 1.10 | 2.00100 | 29.1 | |
| 33 | −34.529 | 16.85 | | | |
| Image Plane | ∞ | | | | |

### Aspheric Data

### 1st Surface

K=0.00000e+00 A 4=1.43080e−07 A 6=−3.60971e−09 A 8=3.90689e−11 A10=−9.24067e−14 A12=1.02941e−16 A14=−4.56015e−20

### 2nd Surface

K=−1.26528e+00 A 4=2.03157e−05 A 6=8.32472e−10 A 8−−2.79434e−10 A10=2.15327e−12 A12=−6.81150e−15 A14=6.54481e−18

### 3rd Surface

K=0.00000e+00 A 4=−1.26561e−05 A 6=−8.36736e−08 A 8=6.18279e−10 A10=−9.98654e−13

### 4th Surface

K=0.00000e+00 A 4=5.66918e−07 A 6=−6.27596e−08 A 8=9.66481e−10 A10=−2.52364e−12 A12=9.09062e−15

### 29th Surface

K=0.00000e+00 A 4=−1.25691e−05 A 6=−8.33507e−09 A 8=8.92018e−12 A10=−5.45463e−14 A12=7.21573e−17

VARIOUS DATA

| | |
|---|---|
| Focal Length | 15.42 |
| Fno | 1.45 |
| Half Angle of View (°) | 51.98 |
| Image Height | 19.72 |
| Overall Lens Length | 123.21 |
| BF | 16.85 |

| | | In-focus State at |
|---|---|---|
| | | Object Distance |
| | In-focus State | Where Lateral |
| | at Infinity | Magnification is −0.1× |
| From Object Plane | Infinity | 259.830 |
| To Image Plane | | |
| d21 | 6.08 | 4.13 |
| d30 | 5.34 | 7.29 |

LENS UNIT DATA

| Lens Unit | Starting Surface | Focal Length |
|---|---|---|
| 1 | 1 | 111.42 |
| 2 | 22 | 43.02 |
| 3 | 31 | 132.99 |

SINGLE LENS DATA

| Lens | Starting Surface | Focal Length |
|---|---|---|
| 1 | 1 | −38.66 |
| 2 | 3 | −100.19 |
| 3 | 5 | −66.23 |
| 4 | 6 | 95.72 |
| 5 | 8 | −56.52 |
| 6 | 10 | 23.53 |
| 7 | 11 | −37.94 |
| 8 | 13 | 44.10 |
| 9 | 15 | −183.70 |
| 10 | 18 | 59.70 |
| 11 | 19 | 284.45 |
| 12 | 20 | −65.12 |
| 13 | 22 | 31.01 |
| 14 | 23 | −25.68 |
| 15 | 25 | 44.09 |
| 16 | 27 | 62.44 |
| 17 | 29 | −101.28 |
| 18 | 31 | 36.24 |
| 19 | 32 | −51.52 |

### Numerical Example 5

### UNIT: mm

SURFACE DATA

| Surface No. | r | d | nd | νd | θgF |
|---|---|---|---|---|---|
| 1* | 122.242 | 2.80 | 1.58313 | 59.4 | |
| 2* | 17.150 | 9.08 | | | |
| 3* | 66.939 | 2.50 | 1.80400 | 46.5 | |
| 4* | 36.194 | 1.00 | | | |
| 5 | 23.223 | 2.15 | 2.00069 | 25.5 | |
| 6 | 26.658 | 9.63 | | | |
| 7 | −18.851 | 1.20 | 1.43387 | 95.1 | |
| 8 | −126.534 | 0.52 | | | |
| 9 | 224.310 | 10.54 | 1.75500 | 52.3 | |
| 10 | −15.919 | 1.20 | 1.90366 | 31.3 | |
| 11 | −43.505 | 0.30 | | | |
| 12 | 147.913 | 5.07 | 2.00100 | 29.1 | |
| 13 | −51.304 | 0.29 | | | |
| 14 | 220.281 | 1.30 | 1.85478 | 24.8 | |
| 15 | 65.807 | 3.74 | | | |
| 16 (SP) | ∞ | 1.26 | | | |
| 17 | 65.974 | 4.77 | 1.74320 | 49.3 | |
| 18 | −73.394 | 0.70 | 1.57060 | 20.1 | 0.7782 |
| 19 | −54.080 | 1.10 | 1.66565 | 35.6 | |
| 20 | 332.302 | (Variable) | | | |
| 21 | −33.574 | 5.51 | 1.59282 | 68.6 | |
| 22 | −17.442 | 0.90 | 1.85478 | 24.8 | |
| 23 | −32.738 | 1.21 | | | |
| 24 | 31.427 | 7.48 | 1.49700 | 81.5 | |
| 25 | −47.785 | 0.30 | | | |
| 26 | 163.838 | 3.56 | 1.92286 | 20.9 | |
| 27 | −75.076 | 0.21 | | | |
| 28* | −659.596 | 2.50 | 1.85400 | 40.4 | |
| 29 | 37.848 | (Variable) | | | |
| 30 | 153.035 | 8.15 | 1.49700 | 81.5 | |
| 31 | −22.527 | 1.10 | 1.85478 | 24.8 | |
| 32 | −75.301 | 14.44 | | | |
| Image Plane | ∞ | | | | |

### Aspheric Data

### 1st Surface

K=0.00000e+00 A 4=1.15340e−05 A 6=−1.13219e−08 A 8=1.18913e−11 A10=−2.17324e−14 A12=4.61433e−17 A14=−3.54334e−20

### 2nd Surface

K=−9.44856e−01 A 4=5.33008e−06 A 6=3.05029e−08 A 8=−1.69870e−10 A10=7.70192e−13 A12=−4.56971e−15 A14=6.57283e−18

### 3rd Surface

K=0.00000e+00 A 4=−1.17437e−05 A 6=2.75779e−08 A 8=−7.15484e−11 A10=1.10546e−13

### 4th Surface

K=0.00000e+00 A 4−8.18047e−06 A 6=5.13359e−08 A 8=−8.15633e−11 A10=8.86408e−13 A12=1.13719e−16

### 28th Surface

K=0.00000e+00 A 4=−1.66207e-05 A 6=−6.95908e-09 A 8=−6.03052e-12 A10=7.91456e-14 A12=−9.83138e-17

VARIOUS DATA

| | |
|---|---|
| Focal Length | 18.53 |
| Fno | 1.45 |
| Half Angle of View (°) | 47.16 |
| Image Height | 19.98 |
| Overall Lens Length | 118.22 |
| BF | 14.44 |

| | | In-focus State |
|---|---|---|
| | | at Object Distance |
| | In-focus State | Where Lateral |
| | at Infinity | Magnification is −0.1× |
| From Object Plane | Infinity | 286.039 |
| To Image Plane | | |
| d20 | 8.88 | 6.66 |
| d29 | 4.83 | 7.05 |

LENS UNIT DATA

| Lens Unit | Starting Surface | Focal Length |
|---|---|---|
| 1 | 1 | 41.83 |
| 2 | 21 | 54.70 |
| 3 | 30 | −892.86 |

SINGLE LENS DATA

| Lens | Starting Surface | Focal Length |
|---|---|---|
| 1 | 1 | −34.55 |
| 2 | 3 | −101.70 |
| 3 | 5 | 137.18 |
| 4 | 7 | −51.23 |
| 5 | 9 | 20.07 |
| 6 | 10 | −28.37 |
| 7 | 12 | 38.54 |
| 8 | 14 | −110.21 |
| 9 | 17 | 47.44 |
| 10 | 18 | 355.47 |
| 11 | 19 | −69.79 |
| 12 | 21 | 54.32 |
| 13 | 22 | −44.89 |
| 14 | 24 | 39.38 |
| 15 | 26 | 56.19 |
| 16 | 28 | −41.84 |
| 17 | 30 | 40.13 |
| 18 | 31 | −37.97 |

TABLE 1
summarizes the values for inequalities (1) to (17) in each
numerical example. The optical system according to each numerical
example satisfies all of inequalities (1) to (17).

| | | Ex. 1 | Ex. 2 | Ex. 3 | Ex. 4 | Ex. 5 |
|---|---|---|---|---|---|---|
| In- | (1) | 3.146 | 3.591 | 3.665 | 2.790 | 2.952 |
| equality | (2) | 1.338 | 0.707 | 0.966 | 2.590 | 0.765 |
| | (3) | 6.468 | 1.981 | 6.134 | 4.161 | 1.839 |
| | (4) | 0.103 | 0.028 | 0.156 | −0.062 | 0.045 |
| | (5) | 0.192 | 0.169 | 0.178 | 0.248 | 0.216 |
| | (6) | 0.088 | 0.061 | 0.072 | 0.116 | −0.021 |
| | (7) | 1.074 | 1.311 | 1.127 | 0.915 | 1.283 |
| | (8) | 0.802 | 0.759 | 0.734 | 0.785 | 0.815 |
| | (9) | −1.212 | −1.005 | −0.975 | −2.354 | −0.765 |
| | (10) | 0.043 | 0.124 | 0.295 | 0.173 | 0.252 |
| | (11) | −1.583 | −1.953 | −1.115 | −1.850 | −1.326 |
| | (12) | −1.381 | −2.380 | −3.136 | −3.670 | −3.355 |
| | (13) | −1.272 | −2.052 | −1.482 | −1.624 | −1.280 |
| | (14) | 95.1 | 94.7 | 95.1 | 95.1 | 95.1 |
| | (15) | −3.606 | −4.202 | −3.776 | −3.665 | −2.765 |
| | (16) | 0.179 | 0.179 | | 0.179 | 0.179 |
| | (17) | 0.048 | 0.049 | | 0.054 | 0.052 |

| | | | | | |
|---|---|---|---|---|---|
| f | 14.42 | 14.42 | 12.37 | 15.42 | 18.53 |
| f1 | 60.70 | 36.62 | 43.78 | 111.42 | 41.83 |
| f2 | 45.36 | 51.76 | 45.33 | 43.02 | 54.70 |
| f3 | 164.62 | 236.68 | 171.13 | 132.99 | −892.86 |
| f1A | 140.67 | 507.40 | 79.39 | −248.01 | 411.25 |
| f1B | 293.37 | 102.54 | 278.07 | 179.02 | 100.63 |
| BF | 13.43 | 11.00 | 10.97 | 16.85 | 14.44 |
| β2 | 0.256 | 0.412 | 0.313 | 0.154 | 0.440 |
| β3 | 0.927 | 0.956 | 0.902 | 0.897 | 1.006 |
| DSI | 69.92 | 65.12 | 61.79 | 67.98 | 66.91 |
| f2GRn | −54.99 | −52.02 | −44.19 | −101.28 | −41.84 |
| D23 | 6.98 | 6.47 | 4.33 | 5.34 | 4.83 |
| fG1G2 | −18.34 | −29.58 | −18.34 | −25.04 | −23.71 |
| D2Max | 0.30 | 0.80 | 1.28 | 0.92 | 1.21 |
| rG1R1 | 72.028 | 68.228 | 267.177 | 51.539 | 122.242 |
| rG1R2 | 16.266 | 22.023 | 14.498 | 15.371 | 17.150 |
| rG2R1 | 230.372 | 48.678 | 67.327 | 61.291 | 66.939 |
| rG2R2 | 36.824 | 19.877 | 34.774 | 35.039 | 36.194 |
| νdGfn | 95.1 | 94.7 | 95.1 | 95.1 | 95.1 |
| fGFn | −51.99 | −60.58 | −46.71 | −56.52 | −51.23 |
| θgFp | 0.7782 | 0.7782 | | 0.7782 | 0.7782 |
| νdp | 20.1 | 20.1 | | 20.1 | 20.1 |
| fGp | 302.13 | 291.94 | | 284.45 | 355.47 |

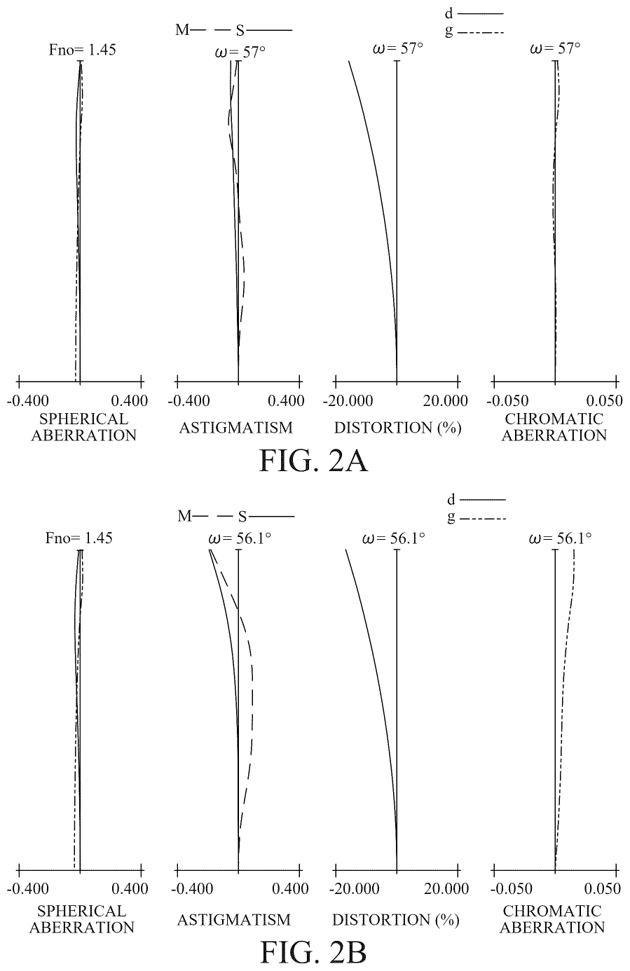

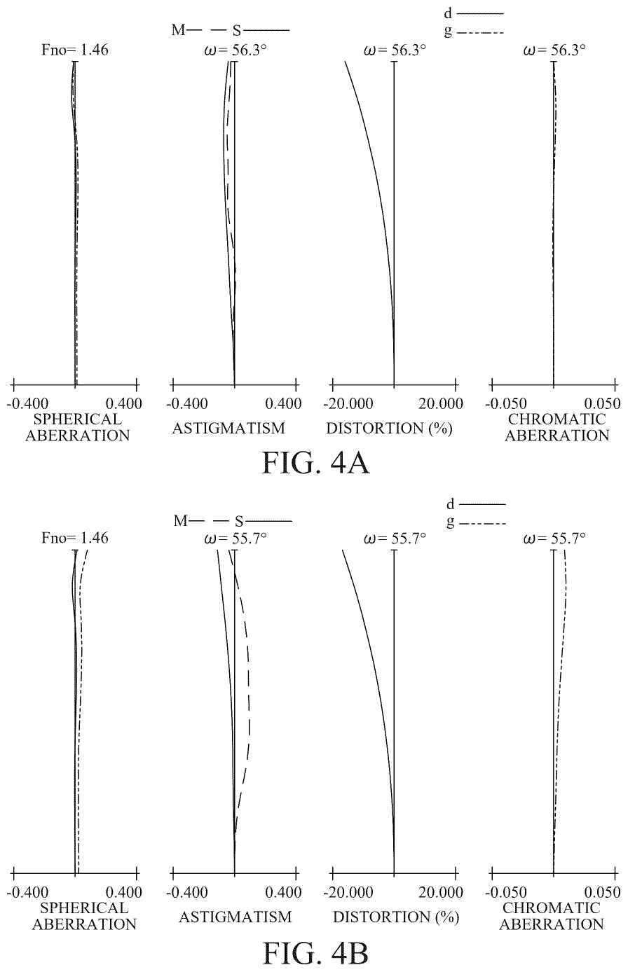

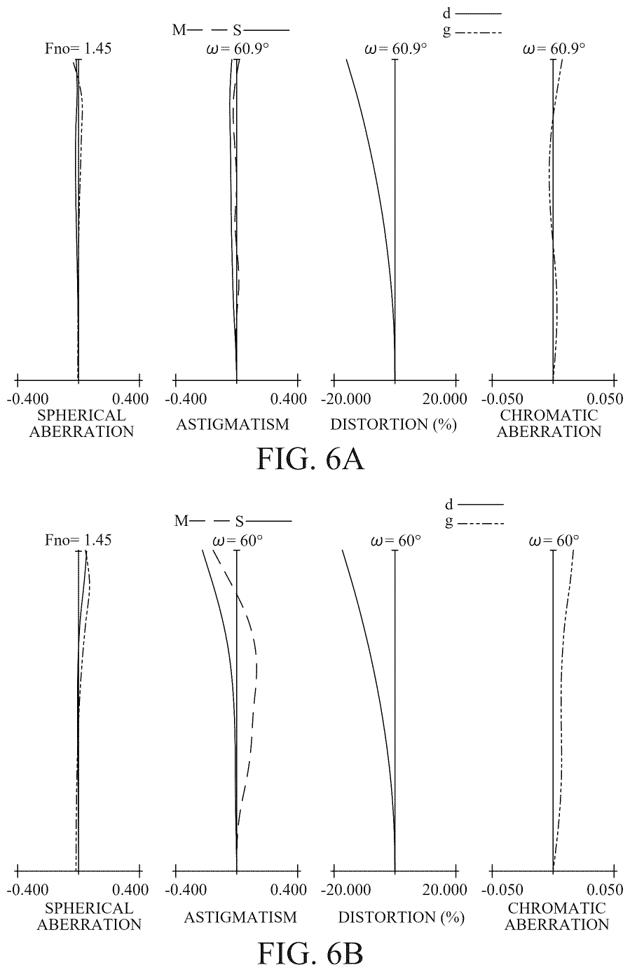

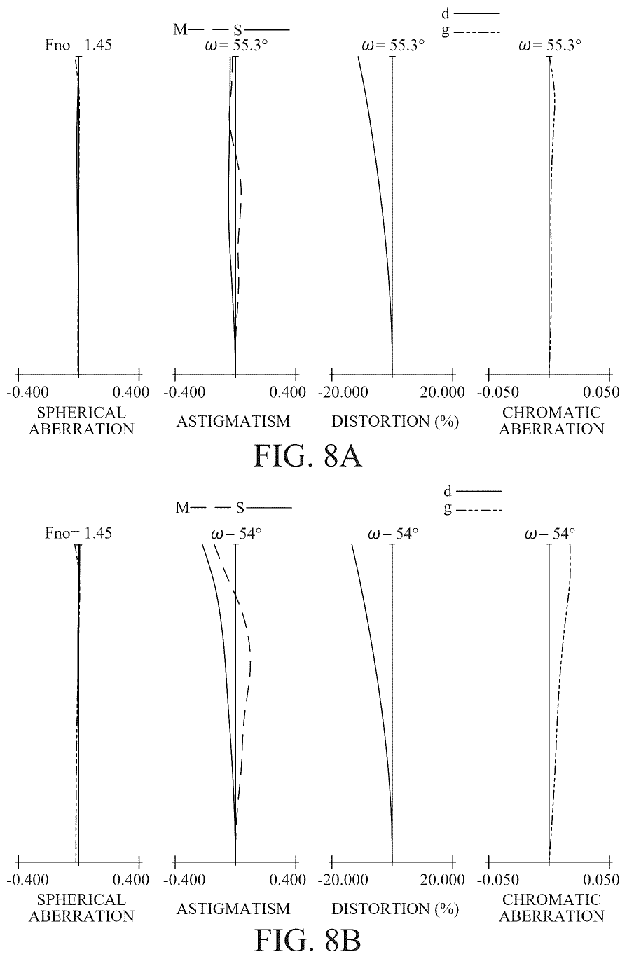

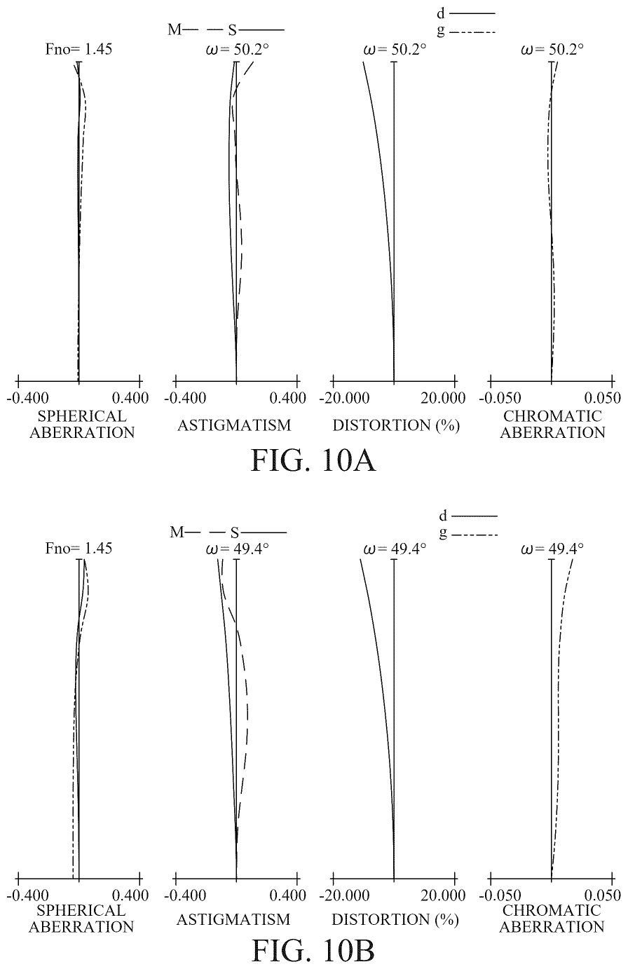

FIGS. 2A, 2B, 4A, 4B, 6A, 6B, 8A, 8B, 10A, and 10B illustrate the longitudinal aberrations (spherical aberration, astigmatism, distortion, and chromatic aberration) of the optical systems L0 according to numerical examples 1 to 5, respectively. In each figure, FIGS. 2A, 4A, 6A, 8A, and 10A illustrate the longitudinal aberrations in the in-focus state at infinity, and FIGS. 2B, 4B, 6B, 8B, and 10B illustrate the longitudinal aberrations in an in-focus state at a distance where the lateral magnification is −0.1×.

In the spherical aberration diagrams, Fno indicates an F-number. A solid line represents a spherical aberration amount for the d-line (wavelength 587.6 nm), and an alternate long and two short dashes line represents a spherical aberration amount for the g-line (wavelength 435.8 nm). In the astigmatism diagrams, a solid line S represents an astigmatism amount on a sagittal image plane, and a broken line M represents an astigmatism amount on a meridional image plane. The distortion diagrams illustrate a distortion amount for the d-line. The chromatic aberration diagrams illustrate a lateral chromatic aberration amount for the g-line. ω indicates the half angle of view (°).

### Image Pickup Apparatus

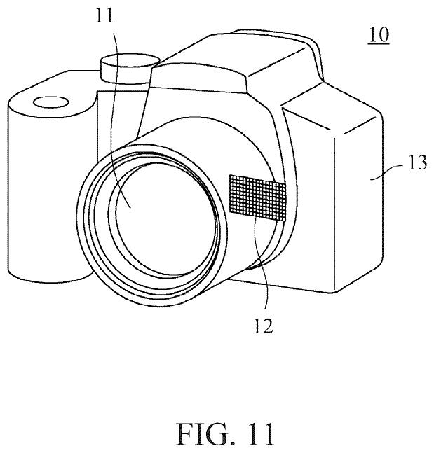

FIG. 11 illustrates a digital still camera (image pickup apparatus) 10 using the optical systems L0 according to Examples 1 to 5 as an imaging optical system. In FIG. 11, reference numeral 13 denotes a camera body. Reference numeral 11 denotes the imaging optical system that includes any one of the optical systems L0 according to Examples 1 to 5 and may be detachably attached to or integrated with the camera body 13. Reference numeral 12 denotes an image sensor, such as a CCD or CMOS sensor, built into the camera body 13, which photoelectrically converts an optical image formed by the imaging optical system 11 (captures an object through the optical system).

The camera body 13 may be a single-lens reflex camera with a quick-turn mirror or a mirrorless camera without a quick-turn mirror.

Using any one of the optical systems L0 according to the respective examples as the imaging optical system can provide high-quality captured images with a wide angle of view while reducing the size and weight of the optical system.

The optical systems L0 according to the above examples may also be used in an image pickup apparatus having an image processing function for correcting aberrations, such as distortion or lateral chromatic aberration.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an optical system that has a reduced size, can suppress performance degradation and changes in the angle of view during focusing.

This application claims the benefit of Japanese Patent Application No. 2025-021520, filed on Feb. 13, 2025, and which is hereby incorporated by reference herein in its entirety.

What is claimed is:

1. An optical system comprising, in order from an object side to an image side:
a first lens unit with positive refractive power;
a second lens unit with positive refractive power; and
a third lens unit,
wherein during focusing, each distance between adjacent lens units changes,
wherein during focusing, the first and third lens units do not move and the second lens unit moves,
wherein the first lens unit includes, in order from the object side to the image side, a first negative lens and a second negative lens, and
wherein the following inequalities are satisfied:
$$2.7 \leq f 2 / f \leq 10 \text{.00}$$
$$0.5 \leq f 1 / f 2 \leq 2.80$$
where f2 is a focal length of the second lens unit, f is a focal length of the optical system, and f1 is a focal length of the first lens unit.

2. The optical system according to claim 1, wherein the first lens unit includes an aperture stop.

3. The optical system according to claim 2, wherein the following inequality is satisfied:
$$1. \leq f 1 B / f 2 \leq 9.00$$
where f1B is a focal length of a subunit closer to an image plane than the aperture stop in the first lens unit.

4. The optical system according to claim 2, wherein the following inequality is satisfied:
$$- 0.30 \leq f / f 1 A \leq 0.30$$
where f1A is a focal length of a subunit closer to an object than the aperture stop in the first lens unit.

5. The optical system according to claim 2, wherein the following inequality is satisfied:
$$0.10 \leq BF / DSI \leq 0.35$$
where BF is an air-equivalent distance on an optical axis from a lens surface closest to an image plane in the optical system to the image plane, and DSI is a distance on the optical axis from the aperture stop to the image plane.

6. The optical system according to claim 1, wherein the following inequality is satisfied:
$$- 0.30 \leq f / f 3 \leq 0.30$$
where f3 is a focal length of the third lens unit.

7. The optical system according to claim 1, wherein the following inequality is satisfied:
$$0.8 \leq f / BF \leq 1.5$$
where BF is an air-equivalent distance on an optical axis from a lens surface closest to an image plane in the optical system to the image plane.

8. The optical system according to claim 1, wherein the following inequality is satisfied:
$$0.5 \leq ( 1 - β22 ) \times β 32 \leq 1.10$$
where β2 is a lateral magnification of the second lens unit in an in-focus state on an object at infinity, and β3 is a lateral magnification of the third lens unit in the in-focus state.

9. The optical system according to claim 1, wherein the following inequality is satisfied:
$$- 3. \leq f GRn / f 2 \leq - 0.50$$
where fGRn is a focal length of a negative lens closest to an image plane among at least one negative lens included in the second lens unit.

10. The optical system according to claim 1, wherein the following inequality is satisfied:
$$0.01 \leq D 2 Max / D 23 \leq 0.60$$
where D2Max is a maximum air gap on an optical axis in the second lens unit, and D23 is a distance on the optical axis from a lens surface closest to an image plane in the second lens unit to a lens surface closest to an object in the third lens unit in an in-focus state on an object at infinity.

11. The optical system according to claim 1, wherein the following inequality is satisfied:
$$- 4.00 \leq ( rG 1 R 2 + rG 1 R 1 ) / ( rG 1 R 2 - rG 1 R 1 ) \leq - 1.$$
where rG1R1 is a paraxial radius of curvature of an object-side lens surface of the first negative lens, and rG1R2 is a paraxial radius of curvature of an image-side lens surface of the first negative lens.

12. The optical system according to claim 1, wherein the following inequality is satisfied:
$$- 4. 0 \leq ( rG 2 R 2 + rG 2 R 1 ) / ( rG 2 R 2 - rG 2 R 1 ) \leq - 1.$$
where rG2R1 is a paraxial radius of curvature of an object-side lens surface of the second negative lens, and rG2R2 is a paraxial radius of curvature of an image-side lens surface of the second negative lens.

13. The optical system according to claim 1, wherein the following inequality is satisfied:
$$- 3. \leq fG 1 G 2 / f \leq - 0.80$$
where fG1G2 is a combined focal length of the first negative lens and the second negative lens.

14. The optical system according to claim 1, wherein the first lens unit includes at least one negative lens with a convex lens surface facing toward the image side, and
wherein the following inequality is satisfied:
$$81. \leq vdGFn \leq 100.$$
where νdGFn is an Abbe number based on d-line of a negative lens closest to an object among the at least one negative lens.

15. The optical system according to claim 14, wherein the following inequality is satisfied:
$$- 6.50 \leq f GFn / f \leq - 2.00$$
where fGFn is a focal length of the negative lens closest to the object.

16. The optical system according to claim 1, wherein the first lens unit includes a positive lens that satisfies the following inequality:
$$0.05 \leq Δθ gFp \leq 0.25$$
where ΔθgFp is an anomalous partial dispersion of the positive lens for g-line and F-line.

17. The optical system according to claim 16, wherein the following inequality is satisfied:
$$0.02 \leq f / fGp \leq 0.090$$
where fGp is a focal length of the positive lens.

18. The optical system according to claim 1, wherein each of the first negative lens and the second negative lens includes a lens surface as an aspheric surface on at least one of the object side and the image side.

19. The optical system according to claim 1, wherein the second lens unit includes at least two positive lenses and at least two negative lenses.

20. An image pickup apparatus comprising:
an optical system; and
an image sensor configured to capture an object through the optical system,
wherein the optical system includes, in order from an object side to an image side:
a first lens unit with positive refractive power,
a second lens unit with positive refractive power, and
a third lens unit,
wherein during focusing, each distance between adjacent lens units changes,
wherein during focusing, the first and third lens units do not move and the second lens unit moves,
wherein the first lens unit includes, in order from the object side to the image side, a first negative lens and a second negative lens, and
wherein the following inequalities are satisfied:
$$2.7 \leq f 2 / f \leq 10 \text{.00}$$
$$0.5 \leq f 1 / f 2 \leq 2.80$$
where f2 is a focal length of the second lens unit, f is a focal length of the optical system, and f1 is a focal length of the first lens unit.
